(19) United States
(12) Patent Application Publication
(10) Pub. No.: US 2014/0077435 A1
(43) Pub. Date: Mar. 20, 2014

(54) Sterilization Base-Tray with Internal Frame and Integrated Latching and Intrument Retention System

(71) Applicant: Andrew Powell, Sanford, ME (US)

(72) Inventor: Andrew Powell, Sanford, ME (US)

(21) Appl. No.: 13/616,180

(22) Filed: Sep. 14, 2012

(51) Int. Cl. B23Q 3/00

(52) U.S. Cl. 269/308

(57) ABSTRACT

The invention relates to product, method and system for materials handling apparatus and more particularly to an integrated design of a vessel for combining sterilization, storage, transport and presentation of dental or surgical instruments or implants using a uniquely designed sterilization base-tray. The simplicity of design and resulting fabrication of a base-tray as a single closed cavity component together with a limited additional number of parts forming the sterilization tray eliminates bacteria colonization as well as lowering manufacturing costs.

### FIELD OF INVENTION

This invention relates to a materials handling apparatus and more particularly to the design of an assembly for facilitating sterilization, storage, transport and presentation of dental or surgical instruments or implants using a combined integral, single component base-tray supporting a finger mat and/or bracket support for instrument or implant retention.

### BACKGROUND OF THE INVENTION

The use of a sterilization tray, container or cassette for sterilization and storage of medical and/or dental instruments or implants is well known, thereby reducing the risk of bacteria build up by combining elements while reducing manufacturing costs. Previous designs all comprise at least three major component containers that include; a lid, a tray and a separate base together with integrated lid latching and instrument retention finger mats and/or bracket systems. Any spacing between the tray and the base allows for a substrate upon which bacteria and other organisms can attach and propagate.

U.S. Pat. No. 7,544,336 to Powell, the full contents of which are hereby incorporated by reference describes an earlier version of a sterilization tray with at least 3 or more molded components that cannot be produced with a simple one-shot molded base-tray component which is the subject of the present disclosure.

Therefore, there exists a need for a single component molded base-tray element sterilization tray that optionally includes an enclosure cover component. In conjunction with this need it is still necessary to offer a cover component providing an elastomeric fit utilized to encompass the single base-tray portion of the sterilization tray. This type of tray will provide for enhanced sterilization and transportation of medical and dental instruments or implants. There has been no previous provision of a combined integral, single component base-tray that supports a finger mat and/or bracket support for instrument retention such that no possible substrate exists for bacteria to grow or propagate.

### SUMMARY

The present disclosure provides a rigid or semi-rigid elastomeric foraminous sterilization base-tray having an internal rigid or semi rigid frame, side walls extending from the perimeter of the base-tray base in a vertical or near vertical angle with one or more integrated lid latches and at least one integrated finger mat or bracket support for instrument retention. A lid is secured to the base-tray via base-tray lid latch(es) such that a foraminous rigid or semi-rigid lid is secured to the side walls of the base-tray thereby providing an integral, single component sterilization tray. The two component lid and base-tray design with integrated instrument retention and latching mechanism(s) is fabricated such that the lid is also attached to the base-tray.

By providing a single component manufacturable base-tray with finger mat and/or bracket supports together with lid latch(es) element(s) which obviates the need for manufacturing separate conventional tray and finger mat or bracket elements, it is possible to eliminate any possible spacing between the conventional tray and finger mat or bracket elements . By eliminating this spacing, one also eliminates the substrate upon which bacteria will propagate. Using the system described above, a single “one-shot” thermoplastic molding operation is possible and highly desirable.

It is also an object of this invention to provide integral tray foot details fabricated within the elastomeric base-tray underside.

It is also an object of this invention to provide the integral rigid or semi rigid frame encapsulated within the elastomeric base-tray.

It is also an object of this invention to promote stacking of the sterilization enclosures for storage or transportation.

It is also an object of this invention to provide a comfortable gripping surface on the outside of the sterilization enclosure.

It is also an object of this invention to enable a color-coded elastomeric tray to allow rapid identification of the enclosed instruments.

It is also an object of this invention to overmold a rigid or semi rigid elastomeric tray with a flexible silicone rubber, or other suitable elastomer, for overmolding to produce a single component base-tray element.

An additional object of the present invention includes providing a base-tray with internal frame, latching mechanism, and instrument retention finger mats or brackets assembly using a single cavity mold, such that the base-tray with the associated latching mechanism, finger mat or other instrument holding methods can be completely produced in a single operation. This single operation base-tray fabrication method often uses a single material composition, encapsulating the internal frame (single port for filling) or with two or more separate materials (two or more ports for filling), where the internal frame is fabricated and subsequently encapsulated by the base-tray material composition. The material composition can be either a virgin resin based elastomeric polymer or a combination of organic elastomeric and inorganic filler components resulting in a composite material composition that is suitable for reducing or eliminating bacteria growth. The use of silver oxide compounds which can be combined with the resin have been shown as effective anti-bacterial, anti-microbial and antiviral agents that also could be used in this application.

Further objects and advantages will become apparent from consideration of the ensuing description and drawings.

### BRIEF DESCRIPTION OF THE DRAWINGS

FIG. 1 illustrates an elastomeric foraminous base-tray with instrument retention finger mat, latching mechanism detail, internal frame and a foraminous lid.

FIG. 2 provides a top view perspective of the base-tray component.

FIG. 3 illustrates an elastomeric tray with instrument retention bracket, latching mechanism detail, internal frame and a foraminous lid.

FIG. 4 illustrates an underside of elastomeric base-tray with an array of sterilization fluid flow through holes, latching mechanism and integrated elastomeric feet.

FIG. 5 illustrates the internal frame.

FIG. 6 illustrates a cross sectional cut away view exposing the internal frame of the elastomeric tray.

### DETAILED DESCRIPTION

For the purpose of representing the principles of the invention, reference will now be made to the drawings and specific language will be used to describe the same. It will nevertheless be understood that no limitation of the scope of the invention is hereby intended, such alterations and further modifications in the illustrated device and such further application of the principles of the invention as illustrated therein being contemplated as would normally occur to one skilled in the art are included as part of the present invention.

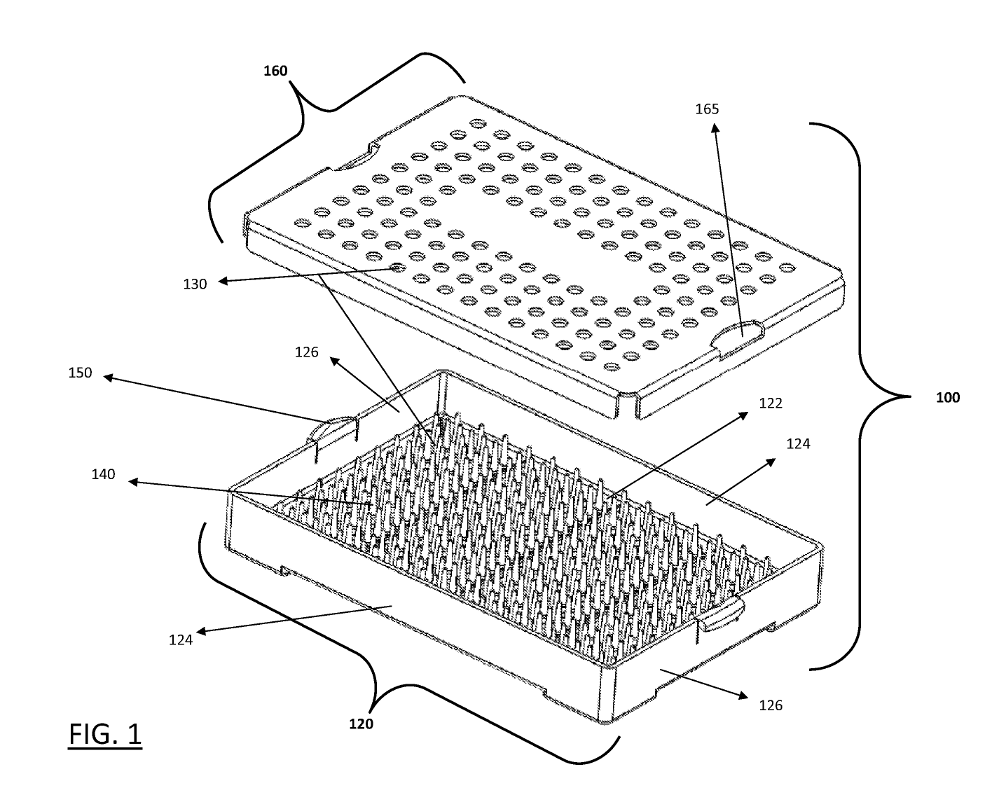

FIG. 1 shows the elastomeric foraminous base-tray and lid unit [100] combination. The base-tray [120] component is depicted with a generally rectangular base portion [122], attached to identical front and rear walls [124] and identical right and left walls [126] that are fabricated within a single element and are nearly perpendicular to the base portion [122] and to each other. The base portion [122] has multiple aperture openings [130], which may be of various shapes, sizes and locations. The base portion [122], in one embodiment, has an instrument retention finger mat [140] fabricated within the single base-tray [120] element. The base-tray's [120] identical right and left walls[126] have one or more base-tray latch details [150] per wall [126] providing a means of securing the lid [160] to the base-tray [120] via the connection between the base-tray latch details [150] and the lid latch interface [165]. The lid [160] is a generally rectangular shape designed to enclose the base-tray [120] securing the base-tray [120] contents (not shown).

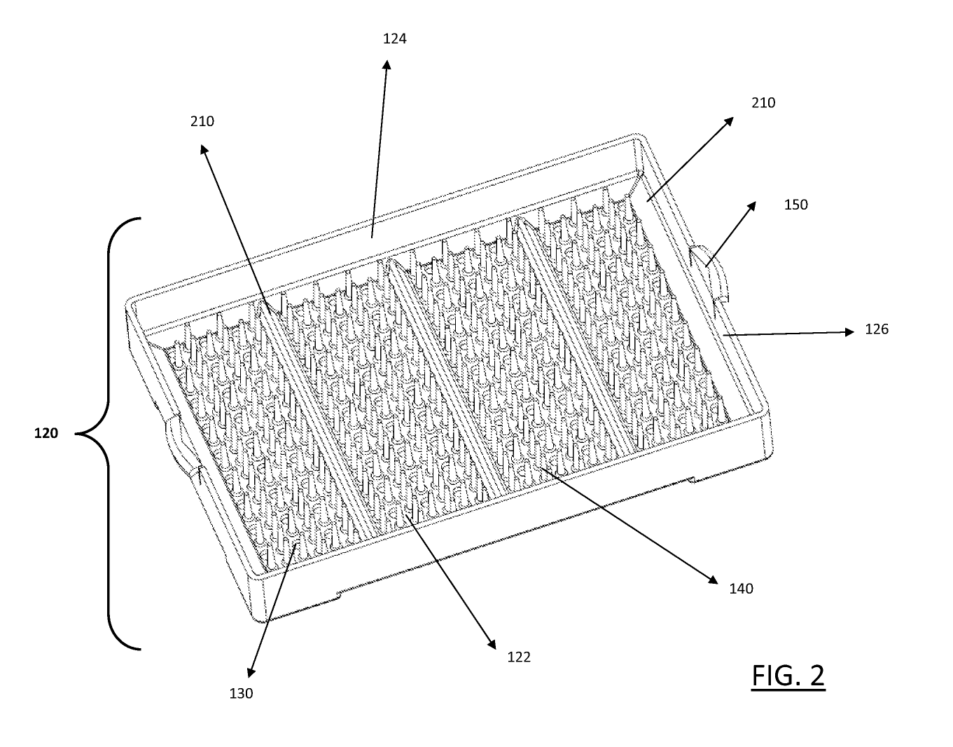

FIG. 2 shows the top perspective view of the base-tray [120] component with a generally rectangular base portion [122], attached to identical front and rear walls [124] and identical right and left walls [126] that are fabricated within a single element and are nearly perpendicular to the base portion [122] and to each other. The base portion [122] has multiple of aperture openings [130], which may be of various shapes, sizes and locations. The base portion [122], in one embodiment, has an instrument retention finger mat [140] fabricated within the base-tray [120] element. The pitched drainage areas [210] are designed to facilitate evacuation of sterilization fluid and steam. The identical right and left walls [126] have two or more base-tray latch details [150] providing a method of securing the lid [160] (not shown) to the base-tray [120].

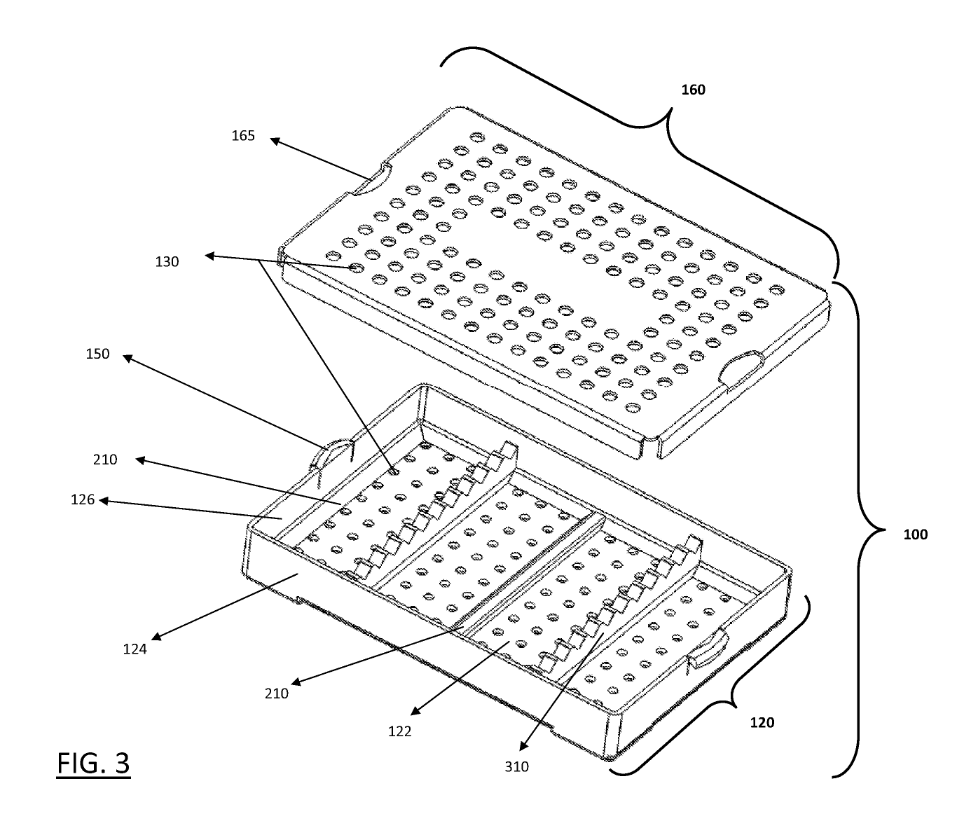

FIG. 3 shows the elastomeric foraminous base-tray and lid unit [100] combination where the base-tray [120] component provides a generally rectangular base portion[122], attached to identical front and rear walls [124] and identical right and left walls [126] that are fabricated within a single element and are nearly perpendicular to the base portion [122] and to each other. The base portion [122] has multiple of apertures [130], which may be of various shapes, sizes and locations. The base portion [122] also, in another embodiment, has instrument retention brackets [310] fabricated within the base-tray [120] element. The identical right and left walls [126]have two or more base-tray latch details [150] providing a method of securing the lid [160] to the base-tray [120] via the connection between the base-tray latch details [150] and the lid latch interface [165]. The lid [160] is a generally rectangular shape designed to enclose the base-tray [120] securing the base-tray [120] contents (not shown).

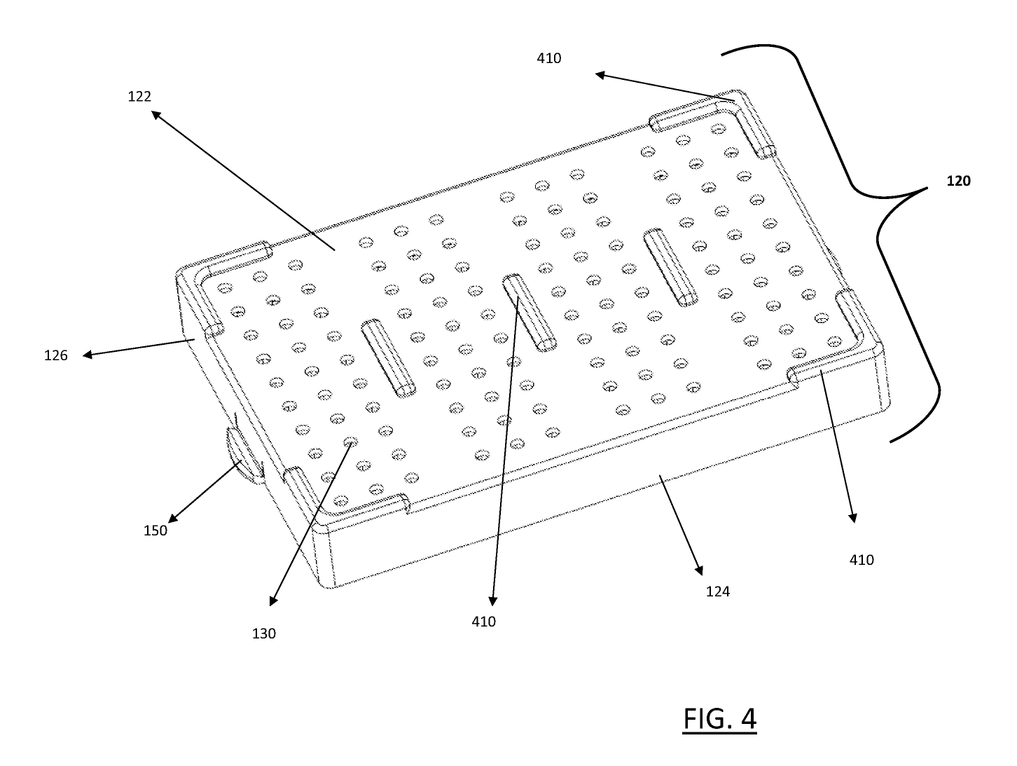

FIG. 4 provides a perspective view of the underside of the base-tray [120] and base portion [122], with the base-tray latch detail [150] underside surface exposed showing details of multiple apertures openings [130] and multiple integrated feet [410] fabricated within a single base-tray [120] element. The integrated feet [410] are placed at various positions, including but not limited to placement in the center of the base portion [122] and at the intersections of the identical front and rear walls [124] with the identical right and left walls [126].

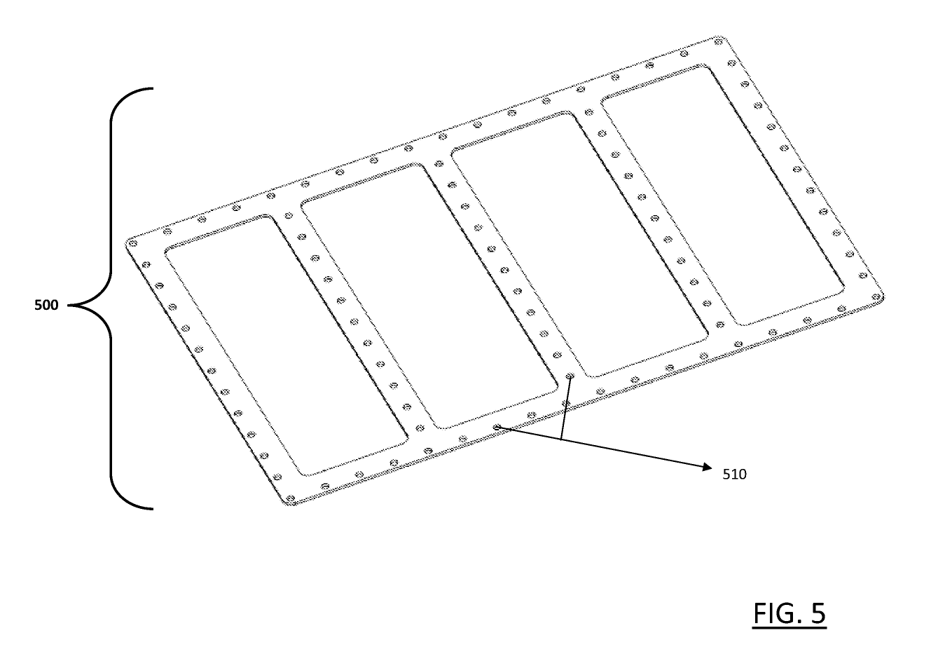

FIG. 5 provides a perspective view of the base-tray internal frame [500] showing details of multiple mechanical bonding aperture openings [510]. The base-tray internal frame [500] is normally encapsulated inside the base-tray [120] component (not shown). This internal frame component [500] is provided prior to encapsulation during molding of the sterilization tray.

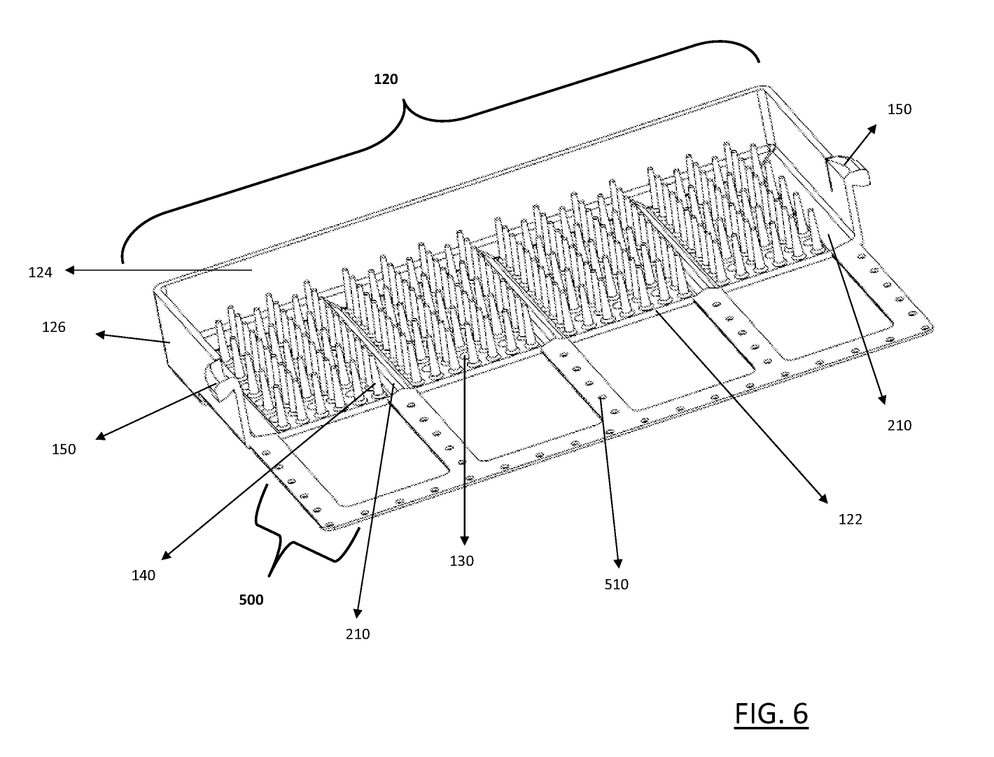

FIG. 6 provides a cross-sectional representation of the base-tray [120] with a portion of the base-tray [120] removed to exhibit the tray internal frame [500] positioning and shows details of optional multiple mechanical bonding aperture openings [510] allowing for additional bonding during encapsulation of the base portion [122]. This base portion [122] is attached to identical front and rear walls [124] and identical right and left walls [126] that are fabricated and provide a single element and are intended to be perpendicular to the base portion [122] as well as to each other. The base portion [122] has multiple apertures [130], which may be of various shapes, sizes and locations. The base portion [122], in the embodiment shown, has an instrument retention finger mat [140] fabricated within the base-tray [120] element. The base-tray [120] base portion [122] includes pitched drainage surfaces [210] to facilitate the evacuation of sterilization fluid and base-tray latch details [150] to facilitate in securing the lid [160] (not shown).

The claims below detail the invention described within the embodiments provided. It will nevertheless be understood that no limitation of the scope of the invention is thereby intended, such alterations and further modifications in the illustrated device and such further application of the principles of the invention as illustrated therein being contemplated as would normally occur to one skilled in the art are included as part of the present invention.

What is claimed is:

1. A sterilization tray for receipt, storage, and retrieval of dental or medical instruments or implants comprising; a rigid or semi-rigid elastomeric foraminous single enclosed cavity base-tray component, said component having an internal rigid or semi-rigid frame, side walls extending from the perimeter of said base-tray base component in a vertical or near vertical angle with one or more integrated base-tray lid latch(es), wherein a lid component is secured to said base-tray component via said base-tray lid latch(es) such that a foraminous rigid or semi rigid-lid is secured to said side walls of said base-tray component thereby providing a combined integral, single component base-tray that supports and a finger mat and/or bracket support for instrument retention.

2. The sterilization tray of claim 1, wherein said lid component is comprised of one or more elastomers thereby forming an elastomeric lid component.

3. The sterilization tray of claim 1, wherein said base-tray does not include a lid component.

4. The sterilization tray of claim 1, wherein said base-tray does not include lid latch(es).

5. The sterilization tray of claim 1 wherein said base-tray and lid design with an integrated latching mechanism is fabricated using elastomeric base-tray sidewalls.

6. The sterilization tray of claim 1, wherein said base-tray is fabricated using various colors, thereby providing identification for each of said dental or medical instruments or implants.

7. The sterilization tray of claim 1, wherein said elastomeric lid component comprises features sufficient for stacking of multiple sterilization trays.

8. The sterilization tray of claim 1, wherein said tray is fabricated with silicone rubber, urethanes, and or other stretchable materials and/or material composites.

9. The sterilization tray of claim 1, wherein said silicon rubber, urethanes or other stretchable materials and/or material composites include the addition of any form of silver oxide.

10. The sterilization tray of claim 1, wherein said elastomeric lid comprises features sufficient for stacking of multiple sterilization trays.

11. The elastomeric lid component of claim 2, wherein said elastomeric lid component is fabricated with silicone rubber, urethanes, and or other stretchable materials and or material composites.

12. The elastomeric lid component of claim 2, wherein said lid is fabricated using various colors, thereby providing identification for each of said dental or medical instruments or implants.

13. A method of covering and holding medical or dental instruments or implants and simultaneously sterilizing said instruments or implants comprising; providing a rigid or semi-rigid elastomeric foraminous base-tray component resulting in a single closed cavity component, said component having an internal rigid or semi-rigid frame, side walls extending from the perimeter of said base-tray base said component having a vertical or near vertical angles with one or more integrated base-tray lid latch(es), wherein a lid component is secured to said base-tray component via said base-tray lid latch(es) such that a foraminous rigid or semi rigid-lid is secured to said side walls of said base-tray component thereby providing a combined integral, single component base-tray that supports and a finger mat and/or bracket support for instrument retention such that said method of sterilizing said instruments or implants results in the elimination of bacteria.

14. The method of claim 13, wherein said lid component is comprised of one or more elastomers thereby forming an elastomeric lid component.

15. The method of claim 13, wherein said base-tray does not include a lid component.

16. The method of claim 13, wherein said base-tray does not include lid latch(es).

17. The method of claim 13, wherein said base-tray and lid design with an integrated latching mechanism is fabricated using elastomeric base-tray sidewalls.

18. The method of claim 13, wherein said base-tray is fabricated using various colors, thereby providing identification for each of said dental or medical instruments or implants.

19. The method of claim 13, wherein said base-tray is fabricated with silicone rubber, urethanes, and or other stretchable materials and/or material composites.

20. The method of claim 13, wherein said silicon rubber, urethanes or other stretchable materials and/or material composites include the addition of any form of silver oxide.

21. The method of claim 14, wherein said elastomeric lid comprises features sufficient for stacking of multiple sterilization trays.

22. The method of claim 14, wherein said elastomeric lid component is fabricated with silicone rubber, urethanes, and or other stretchable materials and or material composites.

24. The method of claim 14, wherein said lid component is fabricated using various colors, thereby providing identification for each of said dental or medical instruments or implants.
